(19) United States
(12) Patent Application Publication
(10) Pub. No.: US 2008/0141230 A1
(43) Pub. Date: Jun. 12, 2008

(54) Scope-Constrained Specification Of Features In A Programming Language

(75) Inventors: Jonathan M. Rowlett, Sammamish, WA (US); Jeffrey P. Snover, Woodinville, WA (US); Bruce G. Payette, Bellevue, WA (US)

Correspondence Address: LEE & HAYES PLLC, 421 W RIVERSIDE AVENUE SUITE 500, SPOKANE, WA, 99201, US

(73) Assignee: MICROSOFT CORPORATION, Redmond, WA (US)

(21) Appl. No.: 11/567,646

(22) Filed: Dec. 6, 2006

(51) Int. Cl. G06F 9/45

(52) U.S. Cl. 717/143

(57) ABSTRACT

A method for scope-constrained specification of features in programming language is disclosed. In an implementation, the method includes modifying a parse tree of a grammar to allow registering of new nodes in the parse tree. A correct node to be utilized for the parse tree is determined and an output program is generated based on the correct node.

### BACKGROUND

In a programming language, there are various grammar features (e.g., semantic, lexical or syntactic features) that make the compilation of the programming language possible. A problem or an error may arise in the existing programming language design and support may be needed for development of domain-specific programming languages. It may also be desirable for a program to be composed of modules with varying syntactic requirements. In addition, different compiler and interpreter vendors may have divergent implementations causing the same syntax to be compiled or interpreted differently. Modification of specification of grammar features to support different modules may result in changing the way existing programs are coded or may lead to misinterpretation of the existing programs with new grammar.

Existing programs may be coded to use a specific interpretation from one compiler but with considerable difficulty to update the code to use a specific interpretation from another compiler. Furthermore, with time, operators and keywords may be added to or removed from a programming language. Operator precedence may also vary between versions of the language, and it may vary between several similar languages.

### SUMMARY

This summary is provided to introduce simplified concepts of scope-constrained specification in features in programming language, which is further described below in the Detailed Description. This summary is not intended to identify essential features of the claimed subject matter, nor is it intended for use in determining the scope of the claimed subject matter.

In an embodiment, a parse tree of a grammar is modified to allow registering of new nodes in the parse tree. A correct node to be utilized for the parse tree is determined and an output program based on the correct node is generated.

### BRIEF DESCRIPTION OF THE FIGURES

The detailed description is described with reference to the accompanying figures. In the figures, the left-most digit(s) of a reference number identifies the figure in which the reference number first appears. The use of the same reference number in different figures indicates similar or identical items.

FIG. 1 is an illustration of an exemplary system for scope-constrained specification of features in programming language.

FIG. 2A is an illustration of tokens generated for a mathematical expression according to an embodiment.

FIG. 2B is an illustration of a parse tree for a mathematical expression in an embodiment.

FIG. 3 is an implementation of an exemplary parser according to an embodiment.

FIG. 4 is an illustration of a modifiable parse tree according to an embodiment.

FIG. 5 is an illustration of an exemplary method for scope-constrained specification of features in a programming language.

FIG. 6 is an illustration of another method for scope-constrained specification of features in a programming language

FIG. 7 is an illustration of an exemplary computing environment for the implementation of the exemplary system and method for scope-constrained specification of features in a programming language.

### DETAILED DESCRIPTION

The following disclosure describes systems and methods for scope-constrained specification of features in programming language. While aspects of described systems and methods for scope-constrained specification of features in programming language can be implemented in any number of different computing systems, environments, and/or configurations, embodiments of modifiable parse trees are described in the context of the following exemplary system architecture(s).

For purposes of exemplary illustrations, a compiler includes a computer program or set of programs that translates text written in a computer programming language (a source language) into another computer language (a target language). One of the reasons for wanting to translate a source language to target language is to create an executable output program. For purposes of exemplary illustration, source code is referred to as input text and target code is referred to as output program. Although a compiler is described, it is to be appreciated that a component of computing device may be implemented in certain embodiments, such as an interpreter.

Existing programs may be compiled using an updated or modified compiler for the programming language to take advantage of performance enhancements and other code generation features. For languages that use literals, keywords and identifiers, for example, C/C++, Pascal, Visual Basic, C#, and Java, etc., it may be desirable to add new keywords, even though existing programs may use identifiers with the same name as a new keyword. Each statement in the programming language may start with either an identifier or a keyword. A parse tree for a statement starting with an identifier, may be identical to the parse tree for a specific keyword.

For purposes of exemplary illustrations, identifiers include textual tokens which name language entities. Entities that an identifier might denote include variables, types, labels, subroutines, and packages. In compiled programming languages, identifiers include compile time entities. Computer languages may place restrictions on what characters may appear in an identifier. A common restriction may include omission of white space characters and language operators.

For purposes of exemplary illustrations, a keyword includes a word or identifier that has a particular meaning to the programming language. In many languages, such as C, a keyword may be a reserved word which identifies a syntactic form.

Systems and methods are disclosed to specify features of a programming language constrained in scope. The disclosed methods and systems extend the meaning of namespaces to include how the parser resolves the syntax and interpretation of language features, especially keywords, literal sequences, and operators, etc. In another implementation, the systems and methods enable versioning of the programming language and allow a programming language designer to partition the definition of programming language features into logical groupings.

In the foregoing context, a namespace includes an abstract container providing context for the items like, names, or technical terms, etc. The namespace may hold and allow disambiguation of items having the same name residing in different namespaces. For many programming languages, a namespace may be a context for identifiers.

Multiple compilers can also develop competing interpretations for the same syntax in different namespaces, and allow a developer to choose which specific interpretation to use.

### Exemplary Compiler

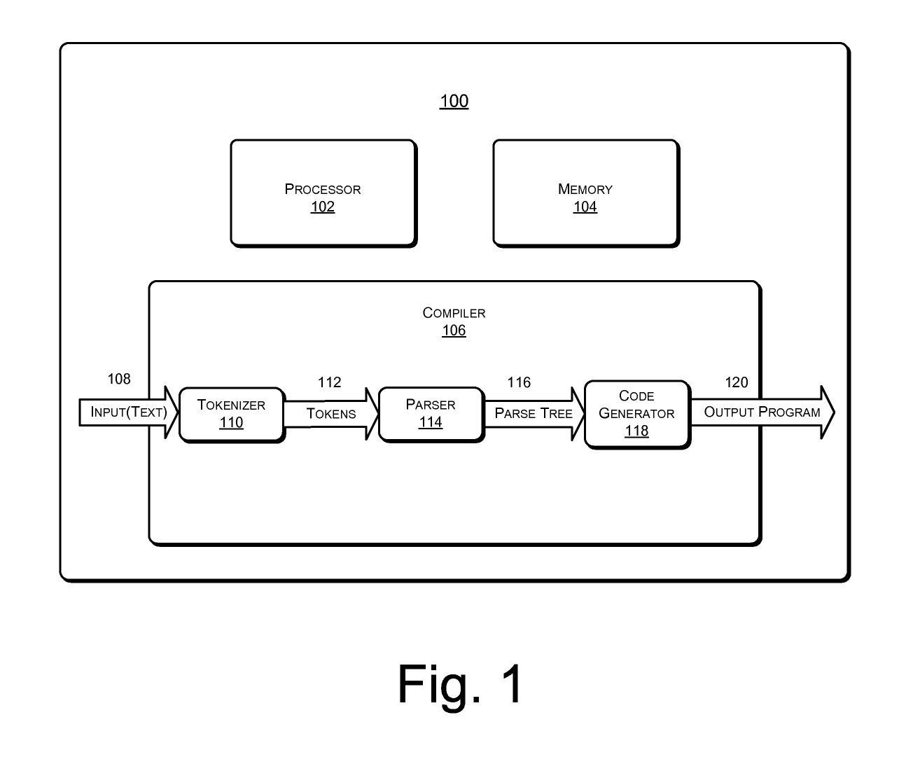

FIG. 1 shows a system 100 for scope-constrained specification of features in programming language. In an exemplary implementation, the system 100 includes one or more processors 102 coupled to a memory 104. Such processors could be for example, microprocessors, microcomputers, microcontrollers, digital signal processors, central processing units, state machines, logic circuitries, and/or any devices that manipulate data based on operational instructions. The processors are configured to fetch and execute computer-program instructions stored in the memory 104. Such memory 104 includes, for example, one or more combination(s) of volatile memory (e.g., RAM) and non-volatile memory (e.g., ROM, Flash etc.). In an exemplary implementation, the memory 104 includes operating system (not shown in the figure) providing a platform for executing applications on the system 100.

The memory 104 stores computer executable instructions and data for scope-constrained specification of features in programming language. It may be appreciated that the scope-constrained specification of features of a programming language may be performed by a compiler 106 which may reside in the memory 104 or may exist as a separate module.

In the exemplary implementation, the compiler 106 includes a tokenizer 110 which demarcates and classifies sections of a string of input text or characters 108. The input text 108 is converted by the tokenizer 110 to tokens 112 which are then passed on for further processing. For purpose of exemplary illustration, the tokens 112 can also be referred to as token strings. A parser 114 receives the tokens 112 and performs parsing of the tokens 112 to generate a parse tree 116.

For purposes of exemplary illustration, parsing includes a process of analyzing an input sequence of source text or input text 108 in order to determine its grammatical structure with respect to a given formal grammar. Syntax of each programming language is defined by the formal grammar. Parsing transforms input text 108 into a data structure, for example, a parse tree 116, which is suitable for later processing and which captures implied hierarchy of the input text 108.

For purposes of exemplary illustration, the parse tree 116 includes a syntax tree that represents the syntactic structure of a string according to the formal grammar. In an implementation, the parse tree 116 is made up of nodes and branches. In the parse tree 116, nodes may be referred to as parent nodes and child nodes. A parent node is one which has at least one other node linked by a branch. Nodes other than parent nodes are referred to as child nodes.

In an implementation, the parser 114 operates in two stages: first, identifying the tokens 112 in the input text 108; and second, constructing a parse tree 116 from the tokens 112. Although, as described above, the tokenizer 110 does the identification of tokens 112, it may be appreciated that the parser may be configured to perform the identification of tokens 112.

In another implementation, the parser 114 may be configured to modify the parse tree 116 to allow registering of new nodes in the parse tree 116 of the grammar. As described above, it may be desirable to modify existing features of a program or add new ones to the existing ones. To this end, the parser 114 enables the compiler 106 to modify the parse tree 116 to include definitions of new nodes in the grammar of the programming language. In an implementation, the new nodes may be overrides of existing nodes or extension sub-nodes of existing nodes.

In the exemplary implementation, the modification of the parse tree 116 is determined and performed by one or more active profiles. For purposes of exemplary illustration, an active profile includes a sequence of namespaces that includes correct nodes that can be parsed at a point in the grammar. In another implementation, the parser 114 parses the received tokens 112 to generate a modified parse tree 116 which includes new nodes defined in the namespaces included in the one or more of the active profile. The parse tree 116 is received by a code generator 118 to generate an output program 120. In an implementation, the output program 120 may include executable programs.

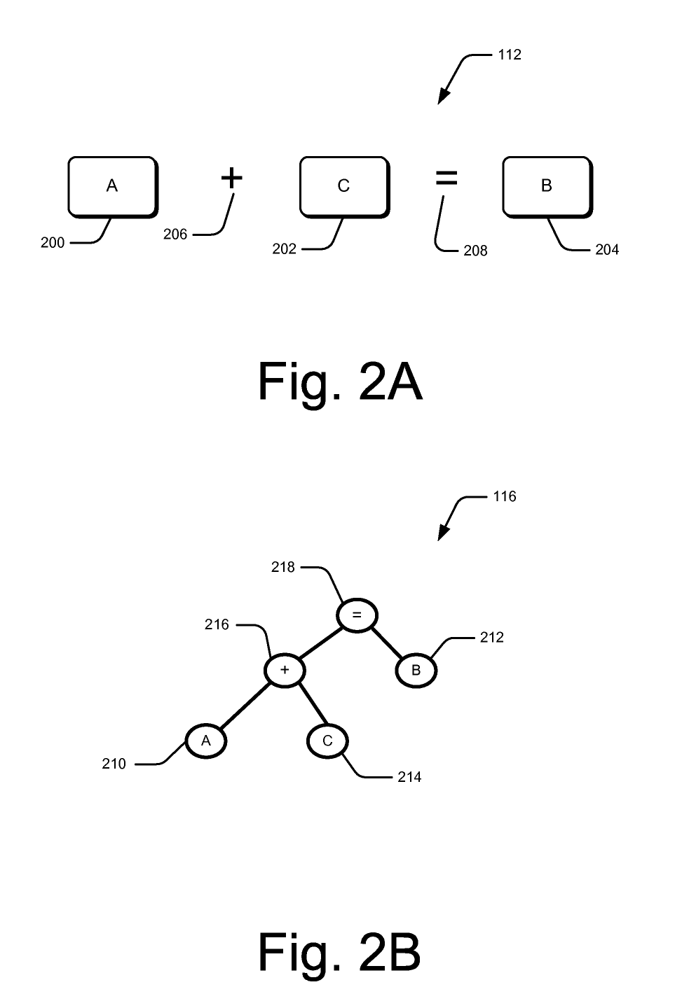

FIG. 2A shows the sequence of tokens 112 as generated by the tokenizer 110 according to an implementation for a mathematical expression as follows: A+C=B.

As shown in the FIG. 2, operands “A”, “C” and “B” are represented by tokens 200, 202, and 206 respectively. In addition, operators “+” and “=” are represented by token 206 and 208 respectively. In an implementation, the tokenizer 110 is associated with one or more token extensions. The token extensions register a sequence of specific characters or character ranges that describe the start of the tokens 112. The token extension is handed control over reading the remaining characters of tokens 112 from the input text 108 once the start of the token 112 is identified. In one of the implementations, the tokenizer 110 may be modified to allow new character sequences, which do not start with white space characters, to be read as tokens. In such an implementation, the token extension is associated with an active profile to define and maintain a sequence of characters to mark the start of token 112. In another implementation, the tokens 112 are generated by the tokenizer 110 in accordance with the active profile.

FIG. 2B illustrates the parse tree 116 according to an implementation. As shown in the figure, the operands “A”, “B”, “C” are represented as nodes 210, 212, 214 and the operators “+” and “=” are represented as nodes 216 and 218 respectively. The parse tree 116 is generated by the parser 114 based on an order of precedence of the operators. It may be appreciated that operator precedence known in the art may be implemented for the purposes of parsing the tokens 112 to generate the parse tree 116. As described above, node 218 is a parent node for child nodes 216 and 218 respectively. Similarly, node 216 is a parent node for child nodes 210 and 214.

In an embodiment, a parent node in the parse tree 116 determines which node to create, by scanning nodes in the active profile that can be child nodes of the parent node. In such an implementation, each child node is registered and parsed according to the requirements of the parent node. For instance, a statement keyword node is registered with a parent statement block with the keyword it uses. The statement block node “peeks” into the tokens 112, which may be token string, and creates a node corresponding to the keyword. The child node now becomes the parent node and scans and selects from the active profile, one or more child nodes, and so on.

In yet another embodiment, each parent node has the ability to pass along the active profile it uses or creates a new active profile that the corresponding child nodes will use to resolve namespaces. In an implementation, a default namespace defines a minimal complete language.

### Exemplary Parser

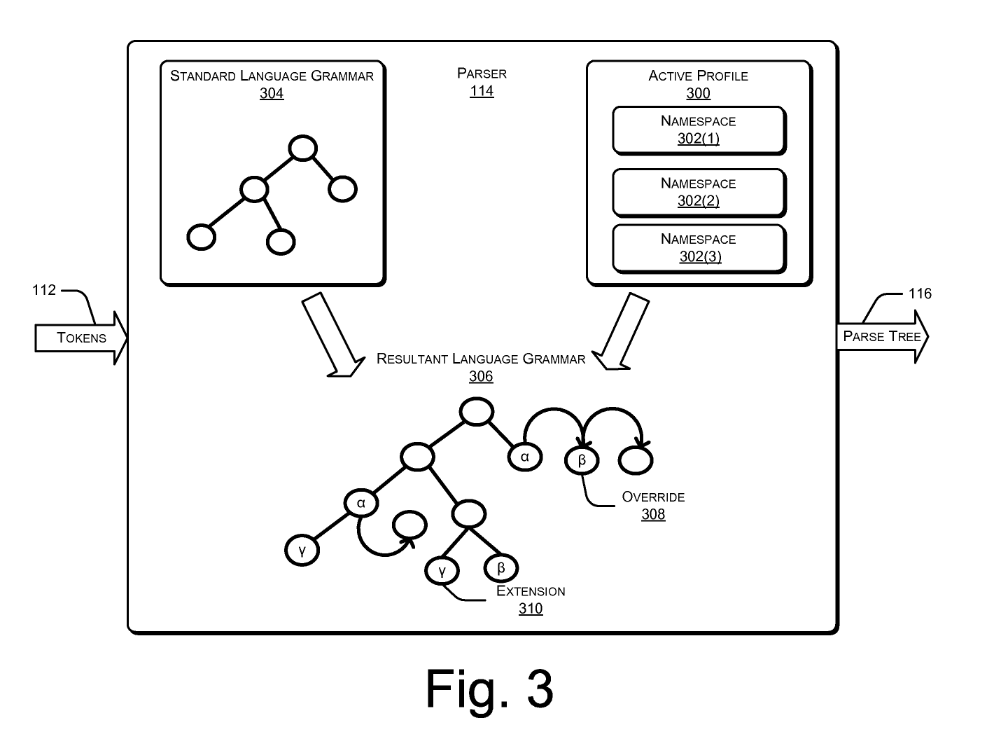

FIG. 3 illustrates an exemplary parser 114 according to an implementation. Accordingly, the parser 114 includes an active profile 300 to define a sequence of namespaces 302(1), 302(2) and 302(3). Although only one active profile 300 is illustrated in the figure, it may be appreciated that one or more active profiles may be implemented. The namespaces 302(1), 302(2) and 302(3) include nodes that can be parsed at any given point in the grammar.

In another implementation, the parser 114 further includes a standard language grammar 304 which includes definitions of features of the programming language. For example, the syntax for the programming language may be defined in the standard language grammar 304. The parser 114 utilizes the standard language grammar 304 to extract syntax information of the programming language.

In the exemplary implementation, the parser 114 may be configured to modify a parse tree 116 to register new nodes associated with the language grammar 304. This may be accomplished by including namespaces that include the new nodes as that may be used at a particular point in the language grammar 304.

In another implementation, the active profile 300 determines the modification of the parse tree 116. In such an implementation, the active profile 300 determines a correct node to be utilized in the modified parse tree 116. In another implementation, the active profile 300 modifies the parse tree 116 by allowing the registering of new nodes in the namespaces 302(1), 302(2), and 302(3). Although only three namespaces have been shown in the figure, it may be appreciated that any number of namespaces 302 may be included in the active profile 300 depending upon the requirement of the parser 114 for parsing the tokens 112. For instance, it may be desirable to include new syntactic, semantic or lexical features in a programming language. Accordingly, the parser 114 may be configured to modify the parse tree 116 to include new nodes registered in one or more namespaces 302 included in the active profile 300.

In the exemplary implementation, a resultant language grammar 306 determines generation of the parse tree 116. As shown in the figure, for each node the parser 114 utilizes the active profile 300 to select and use one or more namespaces 302(1), 302(2), and 302(3). In such an embodiment, a new node registered in the active profile 300 may be an override 308, of the existing node represented as β. In yet another implementation, a new node may be an extension 310 of the existing nodes in the parse tree. Each parent node in the parse tree 116 is capable of passing on the active profile 300 to a corresponding child node included in the parse tree 116. The modifiable parse tree 116 is received by the code generator 118 which generates an output program 120 based on the modifiable parse tree 116.

### Exemplary Modifiable Parser Tree

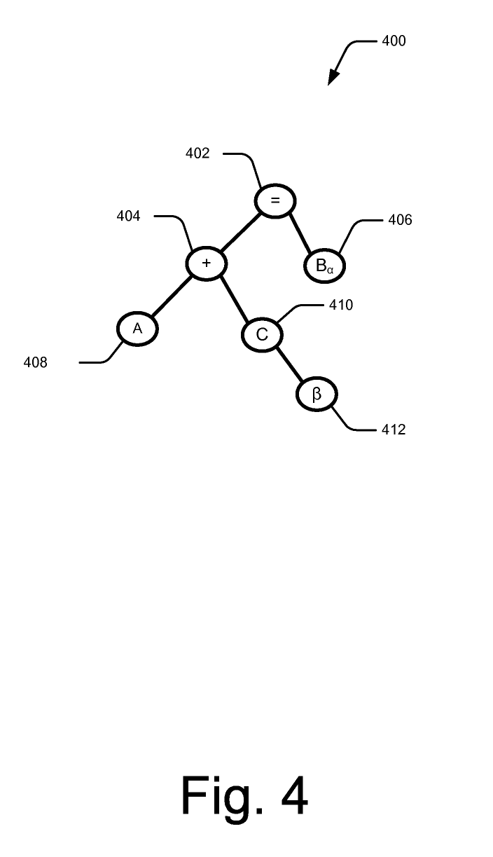

FIG. 4 illustrates a modifiable parse tree 400 which is an instance of a parse tree 116, for a mathematical expression according to an embodiment. Accordingly, the modifiable parse tree 400 represents the mathematical expression: A+C=B.

The modifiable parse tree 400 includes the operator “+” as parent node 402 with the operator “+” and the operand “B_{α}” as the child nodes 404 and 406. As described earlier, the nodes 404 and 406 become the parent nodes for the child nodes 408 and 410 that correspond to the operands “A” and “C” respectively. As shown in the figure, node 410 has yet another child node 412 corresponding to a new node β. The nodes 406 and 412 correspond to new nodes registered by the active profile 300. In an implementation, the modifiable parse tree 400 is modified in accordance with the active profile 300. In an implementation, each parent node determines which node to create as a child node. In another implementation, each parent node passes on the active profile 300 to corresponding child nodes thereby resolving namespace conflicts.

### Exemplary Method

Exemplary methods for scope-constrained specification of features in programming language are described with reference to FIGS. 1 to 4. These exemplary methods may be described in the general context of computer executable instructions. Generally, computer executable instructions can include routines, programs, objects, components, data structures, procedures, modules, functions, and the like that perform particular functions or implement particular abstract data types. The methods may also be practiced in a distributed computing environment where functions are performed by remote processing devices that are linked through a communications network. In a distributed computing environment, computer executable instructions may be located in both local and remote computer storage media, including memory storage devices.

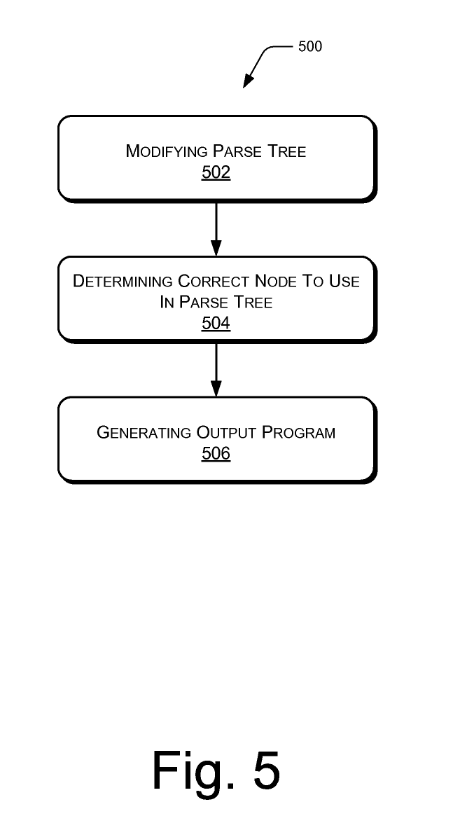

FIG. 5 illustrates an exemplary method 500 for scope-constrained specification of features in programming language. The order in which the method is described is not intended to be construed as a limitation, and any number of the described method blocks can be combined in any order to implement the method, or an alternate method. Additionally, individual blocks may be deleted from the method without departing from the spirit and scope of the subject matter described herein. Furthermore, the method can be implemented in any suitable hardware, software, firmware, or combination thereof.

At block 502, a parse tree is modified to allow a namespace to register new nodes in the parse tree of a grammar. In an exemplary implementation, the parser 114 enables a compiler 106 to modify the parse tree 116 to include definitions of new nodes in the namespaces 302. In such an embodiment, the modification is determined by the active profile 300. In alternate implementations, the new nodes registered may be overrides of existing nodes or extension sub nodes of existing nodes. In an alternate embodiment, new nodes correspond to modification of features in the grammar of a programming language.

At block 504, a correct node is determined to be used in the parse tree. In the exemplary implementation, the active profile 300 determines the correct node to be used in the parse tree 116. The correct node may be an existing node or a new node registered at block 502. In an alternate embodiment, the active profile 300 used by a parent node in the parse tree 116, is passed on to corresponding child node.

At block 506, an output program is generated based on the correct node determined at block 504. In the exemplary embodiment, the parse tree 116 modified by the active profile 300 is received by the code generator 118 and an output program 120 is generated based on the tree. In another implementation, the parse tree 116 includes correct node determined at block 504 and the output program 118 is based on the correct node in the parse tree 116.

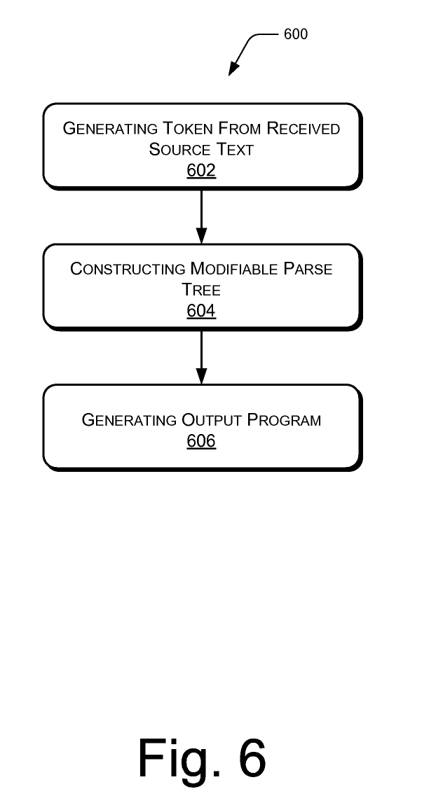

FIG. 6 illustrates a method 600 for scope-constrained specification of features in programming language according to another implementation. The order in which the method is described is not intended to be construed as a limitation, and any number of the described method blocks can be combined in any order to implement the method, or an alternate method. Additionally, individual blocks may be deleted from the method without departing from the spirit and scope of the subject matter described herein. Furthermore, the method can be implemented in any suitable hardware, software, firmware, or combination thereof.

Accordingly, at block 602, a token string is generated by a tokenizer, from received source text. In an exemplary implementation, the source text or the input text 108 is received by the tokenizer 110 which generates a token string or tokens 112. In alternate embodiment, the tokenizer 110 generates tokens in accordance with one or more active profiles 300. In yet another implementation, the tokenizer 110 is associated with one or more modifiable token extensions. In such an implementation, the token extensions are modifiable to mark the start of a token string. For example, the modifiable token extension allows new character sequences that do not start with white space characters to be read as tokens 112 according to the active profile 300. Each such token extension registers a sequence of specific characters or character ranges that describes the start of the token.

At block 604, a modifiable parse tree is constructed from the tokens generated at block 602, by a parser. In the exemplary implementation, the parser 114 creates a modifiable parse tree 400 based on the tokens 112 generated by the tokenizer at block 602. In an alternate embodiment, the modifiable parse tree 400 is created by the parser 114 in accordance with one or more active profiles 300. In such an implementation, the one or more active profiles 300 determine correct nodes to be used in the modifiable parse tree 400. The one or more correct nodes pass on the one or more active profiles 300 used by them, to nodes in the modifiable parse tree 400.

At block 606, an output program is generated by a code generator based on the modifiable parse tree generated at block 604. In the exemplary implementation, the code generator 118 generates an output executable program 120 based on the modifiable parse tree 400.

### Exemplary Computer Environment

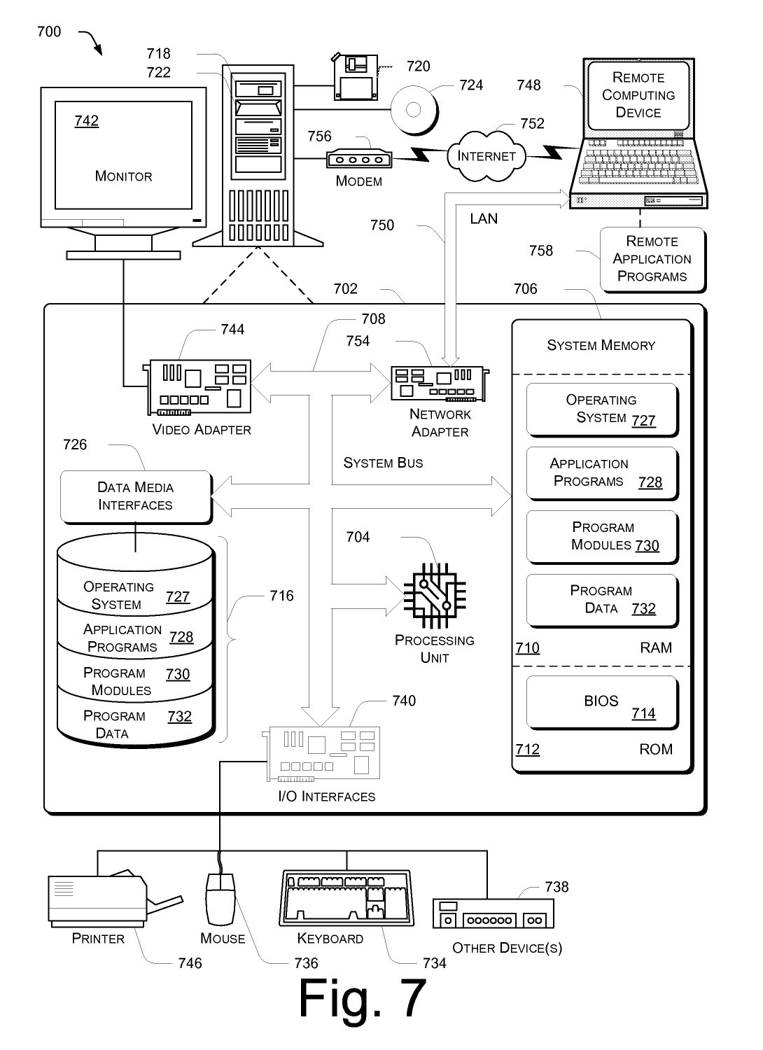

FIG. 7 illustrates an exemplary general computer environment 700, which can be used to implement the techniques described herein, and which may be representative, in whole or in part, of elements described herein. The computer environment 700 is only one example of a computing environment and is not intended to suggest any limitation as to the scope of use or functionality of the computer and network architectures. Neither should the computer environment 700 be interpreted as having any dependency or requirement relating to any one or combination of components illustrated in the example computer environment 700.

Computer environment 700 includes a general-purpose computing-based device in the form of a computer 702. Computer 702 can be, for example, a desktop computer, a handheld computer, a notebook or laptop computer, a server computer, a game console, and so on. The components of computer 702 can include, but are not limited to, one or more processors or processing units 704, a system memory 706, and a system bus 708 that couples various system components including the processor 704 to the system memory 706.

The system bus 708 represents one or more of any of several types of bus structures, including a memory bus or memory controller, a peripheral bus, an accelerated graphics port, and a processor or local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

Computer 702 typically includes a variety of computer readable media. Such media can be any available media that is accessible by computer 702 and includes both volatile and non-volatile media, removable and non-removable media.

The system memory 706 includes computer readable media in the form of volatile memory, such as random access memory (RAM) 710, and/or non-volatile memory, such as read only memory (ROM) 712. A basic input/output system (BIOS) 714, containing the basic routines that help to transfer information between elements within computer 702, such as during start-up, is stored in ROM 712. RAM 710 typically contains data and/or program modules that are immediately accessible to and/or presently operated on by the processing unit 704.

Computer 702 may also include other removable/non-removable, volatile/non-volatile computer storage media. By way of example, FIG. 7 illustrates a hard disk drive 716 for reading from and writing to a non-removable, non-volatile magnetic media (not shown), a magnetic disk drive 718 for reading from and writing to a removable, non-volatile magnetic disk 720 (e.g., a “floppy disk”), and an optical disk drive 722 for reading from and/or writing to a removable, non-volatile optical disk 724 such as a CD-ROM, DVD-ROM, or other optical media. The hard disk drive 716, magnetic disk drive 718, and optical disk drive 722 are each connected to the system bus 708 by one or more data media interfaces 726. Alternately, the hard disk drive 716, magnetic disk drive 718, and optical disk drive 722 can be connected to the system bus 708 by one or more interfaces (not shown).

The disk drives and their associated computer-readable media provide non-volatile storage of computer readable instructions, data structures, program modules, and other data for computer 702. Although the example illustrates a hard disk 716, a removable magnetic disk 720, and a removable optical disk 724, it is to be appreciated that other types of computer readable media which can store data that is accessible by a computer, such as magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, can also be utilized to implement the exemplary computing system and environment.

Any number of program modules can be stored on the hard disk 716, magnetic disk 720, optical disk 724, ROM 712, and/or RAM 710, including by way of example, an operating system 727, one or more application programs 728, other program modules 730, and program data 732. Each of such operating system 727, one or more application programs 728, other program modules 730, and program data 732 (or some combination thereof) may implement all or part of the resident components that support the distributed file system.

A user can enter commands and information into computer 702 via input devices such as a keyboard 734 and a pointing device 736 (e.g., a “mouse”). Other input devices 738 (not shown specifically) may include a microphone, joystick, game pad, satellite dish, serial port, scanner, and/or the like. These and other input devices are connected to the processing unit 1504 via input/output interfaces 740 that are coupled to the system bus 708, but may be connected by other interface and bus structures, such as a parallel port, game port, or a universal serial bus (USB).

A monitor 742 or other type of display device can also be connected to the system bus 708 via an interface, such as a video adapter 744. In addition to the monitor 742, other output peripheral devices can include components such as speakers (not shown) and a printer 746 which can be connected to computer 702 via the input/output interfaces 740.

Computer 702 can operate in a networked environment using logical connections to one or more remote computers, such as a remote computing-based device 748. By way of example, the remote computing-based device 748 can be a personal computer, portable computer, a server, a router, a network computer, a peer device or other common network node, and the like. The remote computing-based device 748 is illustrated as a portable computer that can include many or all of the elements and features described herein relative to computer 702.

Logical connections between computer 702 and the remote computer 748 are depicted as a local area network (LAN) 750 and a general wide area network (WAN) 752. Such networking environments are commonplace in offices, enterprise-wide computer networks, intranets, and the Internet.

When implemented in a LAN networking environment, the computer 702 is connected to a local network 750 via a network interface or adapter 754. When implemented in a WAN networking environment, the computer 702 typically includes a modem 756 or other means for establishing communications over the wide network 752. The modem 756, which can be internal or external to computer 702, can be connected to the system bus 708 via the input/output interfaces 740 or other appropriate mechanisms. It is to be appreciated that the illustrated network connections are exemplary and that other means of establishing communication link(s) between the computers 702 and 748 can be employed.

In a networked environment, such as that illustrated with computing environment 700, program modules depicted relative to the computer 702, or portions thereof, may be stored in a remote memory storage device. By way of example, remote application programs 758 reside on a memory device of remote computer 748. For purposes of illustration, application programs and other executable program components such as the operating system are illustrated herein as discrete blocks, although it is recognized that such programs and components reside at various times in different storage components of the computing-based device 702, and are executed by the data processor(s) of the computer.

Various modules and techniques may be described herein in the general context of computer-executable instructions, such as program modules, executed by one or more computers or other devices. Generally, program modules include routines, programs, objects, components, data structures, etc. that performs particular tasks or implement particular abstract data types. Typically, the functionality of the program modules may be combined or distributed as desired in various embodiments.

An implementation of these modules and techniques may be stored on or transmitted across some form of computer readable media. Computer readable media can be any available media that can be accessed by a computer. By way of example, and not limitation, computer readable media may comprise “computer storage media” and “communications media.”

“Computer storage media” includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

Alternately, portions of the framework may be implemented in hardware or a combination of hardware, software, and/or firmware. For example, one or more application specific integrated circuits (ASICs) or programmable logic devices (PLDs) could be designed or programmed to implement one or more portions of the framework.

### CONCLUSION

The above-described methods and computer describe scope-constrained specification of features in programming language. Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method comprising:
modifying a parse tree of a grammar to allow a namespace to register new nodes in the parse tree;
determining a correct node to use in the parse tree; and
generating an output program based on the correct node.

2. The method of claim 1, wherein the modifying comprises registering new nodes that are overrides of existing nodes in the grammar.

3. The method of claim 1, wherein the modifying comprises registering new nodes that are extension sub nodes of existing nodes.

4. The method of claim 1, wherein the modifying is determined by an active profile.

5. The method of claim 1, wherein the determining is performed by an active profile.

6. The method of claim 1 further comprising passing on active profiles used by nodes in the parse tree.

7. The method of claim 1, implemented in a compiler of a computing device.

8. An component in a computing device comprising:
a tokenizer that receives source text to be compiled, and outputs a token string;
a parser that receives the token string and creates a modifiable parse tree; and
a code generator that receives the modifiable parse tree and outputs an executable program.

9. The component as in claim 8, wherein the tokenizer outputs the token string in accordance with one or more active profiles.

10. The component as in claim 8, wherein the tokenizer is associated with one or more modifiable token extensions marking the start of a token string.

11. The component as in claim 8, wherein the modifiable parse tree is created in accordance with one or more active profiles.

12. The component as in claim 11, wherein the one or more active profiles determine correct node for use in the modifiable parse tree.

13. The component as in claim 12, wherein the correct node passes on the one or more active profiles to next correct node in the modifiable parse tree.

14. One or more computer readable media comprising computer executable instructions that, when executed implements the compiler as in claim 8.

15. One or more computer readable media comprising computer-executable instructions that, when executed by a computer perform acts comprising:
generating a token from received source text;
constructing a modifiable parse tree from the token; and
generating an output program based on the modifiable parse tree.

16. One or more computer readable media as in claim 15 further comprising computer-executable instructions that, when executed by a computer perform acts comprising generating the token starting from predetermined character sequence in the source text.

17. One or more computer readable media as in claim 15 further comprising computer-executable instructions that, when executed by a computer perform acts comprising constructing modifiable parse trees in accordance with one or more active profiles.

18. One or more computer readable media as in claim 15 further comprising computer-executable instructions that, when executed by a computer perform acts comprising registering new nodes in a grammar, the new nodes being overrides or sub extensions of existing nodes.

19. One or more computer readable media as in claim 18 further comprising computer-executable instructions that, when executed by a computer perform acts comprising determining one or more correct nodes to use in the modifiable parse tree.

20. One or more computer readable media as in claim 19 further comprising computer-executable instructions that, when executed by a computer perform acts comprising passing the one or more active profiles to one or more correct nodes.
